(19) United States
(12) Patent Application Publication
(10) Pub. No.: US 2022/0112353 A1
(43) Pub. Date: Apr. 14, 2022

(54) Method for Preparing Ultra-high Wear-Resistant Graphene Epoxy Resin Composites

(71) Applicant: Dalian University of Technology, Dalian (CN)

(72) Inventors: Zhenyu ZHANG, Dalian (CN); Yuefeng DU, Dalian (CN); Dongdong LIU, Dalian (CN); Liangchao GUO, Dalian (CN)

(21) Appl. No.: 17/196,662

(22) Filed: Mar. 9, 2021

(30) Foreign Application Priority Data
Oct. 14, 2020 (CN) 202011093884.1

(51) Int. Cl. C08K 3/04

(52) U.S. Cl. CPC C08K 3/042; C08K 2201/005

(57) ABSTRACT

The present invention provides a preparation method for ultra-high wear-resistant graphene epoxy resin composites, belonging to the technical field of macroscopic lubrication. The present invention firstly adopts a physical blending method to uniformly mix graphene powder and epoxy resin, and then cures the mixture at high temperature to prepare graphene epoxy resin composites with ultra-low wear rate. The present invention adopts a solution blending method to uniformly combine graphene and epoxy resin, improving the friction and wear performance of epoxy resin and expanding the application of epoxy resin in the field of tribology.

### FIELD OF THE INVENTION

The present invention provides a preparation method for ultra-high wear-resistant graphene epoxy resin composites, belonging to the technical field of macroscopic lubrication.

### BACKGROUND

As high-performance engineering polymer thermosetting resin, epoxy resin is widely used in the fields such as semiconductor packaging, petrochemical industry, aerospace, automobile and high-voltage electrical equipment due to excellent tensile strength, high stiffness, low curing shrinkage and chemical corrosion resistance. In some cases, sliding elements are made from epoxy resin to withstand friction and wear. However, the further application of epoxy resin is limited due to high brittleness, low sub-fatigue and poor tribological property caused by cured three-dimensional cross-linked network structure. In order to improve the tribological property of epoxy resin, an effective and widely accepted solution is to combine epoxy resin with various nano materials.

As a new two-dimensional carbon material, graphene has excellent mechanical property and stable structure, and is not easily damaged under strong external loads. The connection between carbon atoms is very flexible due to strong C-C covalent bond in the graphene layers. When an external force is applied, the surfaces of the carbon atoms bend and deform, while the carbon atoms can maintain good structural stability without rearrangement. Meanwhile, graphene has atomic-scale thickness, lamellar structure with low shear strength, high mechanical strength, low surface energy, and chemical stability in harsh environments. In addition, graphene has the characteristic of the same friction coefficient under dry and wet conditions, which is extremely rare. Therefore, graphene can be used as an ideal filler to improve the friction and mechanical properties of epoxy resin.

### SUMMARY OF THE INVENTION

To solve the problems in the prior art, the present invention provides a preparation method for ultra-high wear-resistant graphene epoxy resin composites.

The technical solution of the present invention is:

A method for preparing ultra-high wear-resistant graphene epoxy resin composites firstly adopts a physical blending method to uniformly mix graphene powder and epoxy resin, and then cures the mixture at high temperature to prepare graphene epoxy resin composites with ultra-low wear rate, comprising the following steps:

Step 1, adding a curing accelerator to an epoxy resin solution, wherein the mass ratio of the curing accelerator to the epoxy resin is 1:1000-5:1000, and stirring for 6-10 h at 70-90° C. to evenly disperse the curing accelerator in the epoxy resin solution to obtain a mixed solution A; and after cooling, adding a curing agent to the mixed solution A, wherein the mass ratio of the epoxy resin to the curing agent is 100:98-100:90, and then mixing with a mixer until the curing agent is evenly dispersed to obtain a mixed solution B;

Step 2, adding graphene powder to the mixed solution B obtained in step 1, wherein the mass concentration of the graphene powder in the mixed solution B is 1-7 wt. %, and using a solution blending method to evenly disperse the graphene powder in the epoxy resin solution to obtain a mixed solution C; then pouring the mixed solution C into a mold and vacuum degassing at 45-70° C. to remove bubbles in the solution, wherein the degassing time is 2-6 h;

Step 3, pre-curing the mixed solution C degassed in step 2 to a soft gel state at normal pressure and 110-145° C. for 2-4 h, and then completely curing it at 145-180° C. for 10-16 h to obtain ultra-high wear-resistant graphene epoxy resin composites.

The graphene powder is at least one of graphene, graphene oxide and reduced graphene oxide power; and the particle size of the graphene powder is 10-15 μm.

The epoxy resin is at least one of bisphenol A type epoxy resin, bisphenol F type epoxy resin, polyphenol glycidyl ether epoxy resin and glycidyl ester epoxy resin.

The curing agent is a heat-curing anhydride curing agent such as methylhexahydrophthalic anhydride, phthalic anhydride and oxydiphthalic anhydride.

The curing accelerator is at least one of tertiary amine and derivatives thereof, quaternary ammonium salt and acetylacetone metal salt, such as dimethylaminomethylphenol and neodymium(III) acetylacetonate.

In step 1, the addition of the curing accelerator is to increase the curing rate of the epoxy resin, reduce the curing temperature and shorten the curing time; and accelerator of acetylacetonate salts can improve the strength, heat resistance and water resistance of the cured resin; the stirrer used for stirring is a heat-collecting thermostatic heating magnetic stirrer, and the heating liquid is silicone oil; and the revolving speed of the mixer is preferably 2500 rpm/min, and the mixing time is preferably 5 min, which may uniformly mix the epoxy resin and the curing agent to improve the curing effect.

In step 2, the instrument used in the solution blending method is a mixer, the revolving speed is preferably 2500 rpm/min, and the mixing time is preferably 5 min; and the degassing process may exhaust the air mixed in the solution during the mixing process so that the cured sample has uniform texture without bubbles, having no influence on the performance test.

The present invention has the following beneficial effects: the present invention adopts a solution blending method to uniformly combine graphene and epoxy resin, improving the friction and wear performance of epoxy resin; the wear rate is improved greatly even hundreds times, compared with that of pure epoxy. The present invention expands the application of epoxy resin in the field of tribology.

### BRIEF DESCRIPTION OF THE DRAWING

FIG. 1 is a statistical diagram of the wear rate of graphene epoxy resin composites with different graphene contents in embodiments 1-3.

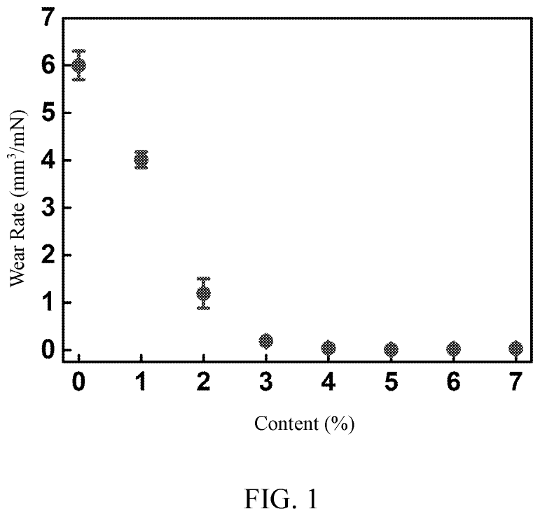

### DETAILED DESCRIPTION OF THE INVENTION

Some embodiments of the present invention are described below in detail in combination with the technical solution and drawings.

The ultra-high wear-resistant graphene epoxy resin composites of the present invention are prepared in three embodiments, and the wear rate of the prepared product is analyzed.

In the analysis of the wear rate, the measuring equipment is a ball-disc type multi-functional high-temperature friction and wear tester, and the friction counterpart is a GCr15 steel ball with diameter of 3 mm. Before test, #800 and #3000 abrasive papers are used to polish the surface of a graphene epoxy resin composite test piece. The test is conducted at room temperature under the relative humidity of 65%; and the applied load is 10 N, the friction distance is 5 mm, the swing frequency is 2 Hz, and the test time is 1800 s.

The test is conducted for three times under the condition of different contents, and the wear rate is obtained by measuring the polishing scratch by a white light interferometer. After test, the cross-sectional area S of the polishing scratch is measured by the integral method, and then multiplied by the length L of the scratch to obtain the wear volume V. The calculation formula of the wear rate μ is as follows:

μ=V/(F×L) (1)

wherein, F is the applied load; and L is the length of the polishing scratch.

### Embodiment 1

Curing accelerator (dimethylaminomethylphenol) and epoxy resin (bisphenol A type epoxy resin) were mixed with the mass ratio of 5:1000, and then the mixture was stirred for 10 h at 90° C. to evenly disperse the curing accelerator in the epoxy resin solution to obtain a mixed solution A; after cooling, a curing agent (oxydiphthalic anhydride) was added to the mixed solution A, wherein the mass ratio of the epoxy resin to the curing agent was 100:98, followed by stirring with a mixer until the curing agent was evenly dispersed to obtain a mixed solution B; 1 wt. % of graphene powder (graphene) was added to the mixed solution B and was evenly dispersed in the epoxy resin solution by using the solution blending method to obtain a mixed solution C, and then the mixed solution C was degassed in a vacuum at 45° C. for 6 h; and the degassed mixed solution C was pre-cured under normal pressure at 145° C. for 4 h to a soft gel state, and then was completely cured at 180° C. for 16 h to obtain ultra-high wear-resistant graphene epoxy resin composite.

Test of wear rate: the wear rate of the graphene epoxy resin composites with the graphene content of 1% prepared by the method of the present invention is 4×10⁻⁴ mm³/mN, and is improved by 1.5 times compared with 6×10⁻⁴ mm³/mN of pure epoxy resin.

### Embodiment 2

Curing accelerator (neodymium(III) acetylacetonate) and epoxy resin (polyphenol glycidyl ether epoxy resin) were mixed with the mass ratio of 3:1000, then the mixture was stirred for 6 h at 70° C. to evenly disperse the curing accelerator in the epoxy resin solution to obtain a mixed solution A; after cooling, a curing agent (phthalic anhydride) was added to the mixed solution A, wherein the mass ratio of the epoxy resin to the curing agent was 100:90, followed by stirring with a mixer until the curing agent was evenly dispersed to obtain a mixed solution B; 7 wt. % of graphene powder (graphene oxide) was added to the mixed solution B and was evenly evenly dispersed in the epoxy resin solution by using the solution blending method to obtain a mixed solution C, and then the mixed solution C was degassed in a vacuum at 70° C. for 2 h; and the degassed mixed solution C was pre-cured under mormal pressure at 110° C. for 2 h to a soft gel state, and then was completely cured at 145° C. for 14 h until the mixed solution C to obtain ultra-high wear-resistant graphene epoxy resin composite.

Test of wear rate: the wear rate of the graphene epoxy resin composites with the graphene content of 7% prepared by the method of the present invention is 3.06×10⁻⁶ mm³/mN, and is improved by 196 times compared with 6×10⁻⁴ mm³/mN of pure epoxy resin.

### Embodiment 3

Curing accelerator (dimethylaminomethylphenol) and epoxy resin (glycidyl ester epoxy resin) were mixed with the mass ratio of 1:1000, then the mixture was stirred for 8 h at 80° C. to evenly disperse the curing accelerator in the epoxy resin solution to obtain a mixed solution A; after cooling, a curing agent (methylhexahydrophthalic anhydride) was added to the mixed solution A, wherein the mass ratio of the epoxy resin to the curing agent was 100:95, followed by stirring with a mixer until the curing agent was evenly dispersed to obtain a mixed solution B; 5 wt. % of graphene powder (reduced graphene oxide power) was added to the mixed solution B, and was evenly dispersed in the epoxy resin solution by using the solution blending method to obtain a mixed solution C, and then the mixed solution C was degassed in a vacuum at 50° C. for 4 h; and the degassed mixed solution C was pre-cured under normal pressure at 135° C. for 3 h to a soft gel state, and then was completely cured at 165° C. for 16 h to obtain ultra-high wear-resistant graphene epoxy resin composite.

Test of wear rate: the wear rate of the graphene epoxy resin composites with the graphene content of 5% prepared by the method of the present invention is 9.55×10⁻⁷ mm³/mN, and is improved by 628 times compared with 6×10⁻⁷ mm³/mN of pure epoxy resin.

The wear rate of the graphene epoxy resin composites prepared in embodiments 1-3 of the present invention is: 9.55×10⁻⁷-4×10⁻⁴ mm³/mN, and is improved by 1.5 to 628 times compared with 6×10⁻⁴ mm³/mN of pure epoxy, showing that the wear rate of the graphene epoxy resin composites prepared by the method of the present invention is greatly improved.

We claim:

1. A method for preparing ultra-high wear-resistant graphene epoxy resin composites, the method comprising the following steps:
step 1, adding a curing accelerator to an epoxy resin solution, wherein the mass ratio of the curing accelerator to the epoxy resin is 1:1000-5:1000, and stirring for 6-10 h at 70-90° C. to evenly disperse the curing accelerator in the epoxy resin solution to obtain a mixed solution A; and after cooling, adding a curing agent to the mixed solution A, wherein the mass ratio of the epoxy resin to the curing agent is 100:98-100:90, and mixing with a mixer until the curing agent is evenly dispersed to obtain a mixed solution B;
step 2, adding graphene powder to the mixed solution B obtained in step 1, wherein the mass concentration of the graphene powder in the mixed solution B is 1-7 wt. %, and using a solution blending method to evenly disperse the graphene powder in the epoxy resin solution to obtain a mixed solution C; then pouring the mixed solution C into a mold and vacuum degassing at 45-70° C. for 2-6 h to remove bubbles in the solution;
step 3, pre-curing the mixed solution C degassed in step 2 to a soft gel state at normal pressure and 110-145° C. for 2-4 h, and then completely curing at 145-180° C. for 10-16 h to obtain ultra-high wear-resistant graphene epoxy resin composite;
the graphene powder is at least one of graphene, graphene oxide and reduced graphene oxide;
the epoxy resin is at least one of bisphenol A type epoxy resin, bisphenol F type epoxy resin, polyphenol glycidyl ether epoxy resin and glycidyl ester epoxy resin;
the curing agent is a heat-curing anhydride curing agent;
the curing accelerator is at least one of tertiary amine and derivatives thereof, quaternary ammonium salt and acetylacetone metal salt.

2. The method for preparing ultra-high wear-resistant graphene epoxy resin composites according to claim 1, wherein
the graphene powder has a particle size from 10 to 15 μm;
the curing agent is methylhexahydrophthalic anhydride, phthalic anhydride or oxydiphthalic anhydride;
the curing accelerator is dimethylaminomethylphenol or neodymium(III) acetylacetonate.

3. The method for preparing ultra-high wear-resistant graphene epoxy resin composites according to claim 1, wherein
in step 1, a stirrer used for stirring is a heat-collecting thermostatic heating magnetic stirrer, and a heating liquid is silicone oil; and a revolving speed of the mixer is 2500 rpm/min and a mixing time is 5 min;
in step 2, an instrument used in the solution blending method is a mixer, mixing at a revolving speed of 2500 rpm/min for 5 min.

4. The method for preparing ultra-high wear-resistant graphene epoxy resin composites according to claim 2, wherein
in step 1, a stirrer used for stirring is a heat-collecting thermostatic heating magnetic stirrer, and a heating liquid is silicone oil; and a revolving speed of the mixer is 2500 rpm/min and a mixing time is 5 min;
in step 2, an instrument used in the solution blending method is a mixer, mixing at a revolving speed of 2500 rpm/min for 5 min.
